(19) United States
(12) Patent Application Publication
(10) Pub. No.: US 2013/0208754 A1
(43) Pub. Date: Aug. 15, 2013

(54) LASER APPARATUS, COMPONENT, METHOD AND APPLICATIONS

(71) Applicants: Leonid Glebov, Orlando, FL (US); Apurva Jain, Orlando, FL (US); Vadim Smirnov, Orlando, FL (US); Christine Spiegelberg, Winter Park, FL (US); George Venus, Oviedo, FL (US)

(72) Inventors: Leonid Glebov, Orlando, FL (US); Apurva Jain, Orlando, FL (US); Vadim Smirnov, Orlando, FL (US); Christine Spiegelberg, Winter Park, FL (US); George Venus, Oviedo, FL (US)

(73) Assignees: OptiGrate Corp., Orlando, FL (US); University of Central Florida Research Foundation Inc., Orlando, FL (US)

(21) Appl. No.: 13/370,729

(22) Filed: Feb. 10, 2012

(51) Int. Cl. H01S 3/08; H01S 3/13

(52) U.S. Cl. 372/99; 359/337.21

(57) ABSTRACT

A method for two-dimensional spatial (transverse) mode selection in waveguide and free-space laser resonators and associated laser systems employing said resonators. The invention is based on the cylindrical symmetry of the angular selectivity of reflecting volume Bragg gratings (R-VBGs) that are used as spectrally selective minors in resonators. Matching the divergence of a laser beam and the angular selectivity a reflecting volume Bragg grating can establish different losses for transverse modes of different orders, while not restricting the aperture of the laser resonator, and enables single mode operation for resonators that support a plurality of transverse modes. The invention provides a laser having increased brightness without a decrease of efficiency.

### GOVERNMENT SPONSORSHIP

This invention was made with government support under DARPA HR0011-09-C-0089 and AFRL FA9451-10-C-0006. The U.S. government has certain rights in the invention.

### RELATED APPLICATION DATA

N/A.

### TECHNICAL FIELD

Embodiments of the present invention relate generally to laser systems, optical resonators used in laser systems, associated methods, and applications thereof. More particular embodiments pertain to such systems, resonators, methods, and applications that include a reflecting volume Bragg grating (R-VBG) for simultaneous two-dimensional transverse and longitudinal mode selection, and improved laser characteristics and performance.

### BACKGROUND

Volume Bragg gratings (VBGs) are widely used for both angular (spatial) and spectral selection in various types of lasers, spectral analyzers, and other optical apparatus. Transmitting VBGs (T-VBGs), which can have sharp angular selectivity (e.g., Δθ≈0.002 degrees) in the plane of diffraction (planar angular selectivity) are typically used to provide one-dimensional (planar) angular selection in optical beams propagating in free space; thus, two sequential transmitting VBGs are required for two-dimensional (2-D) angular selection. Reflecting VBGs (R-VBGs), which have extraordinary narrow spectral selectivity (e.g., Δλ/λ≈10⁻⁵), typically provide spectral selection in optical beams propagating in free space. However, R-VBGs are not typically used to provide angular selection in collimated laser beams because angular selectivity of available R-VBGs is orders of magnitude wider than typical collimated laser beams propagating in free space.

Volume Bragg gratings have proven their usefulness for spectral stabilization of many types of lasers like solid state, semiconductor, and fiber lasers. Their additional selectivity in the spatial/angular domain sets them apart from other wavelength selective components such as multilayer dielectric minors or fiber Bragg gratings, for example.

Spatial (transverse) mode selection is an engineering function in any laser design. There are many approaches used to restrict lasing to specific transverse modes of a laser cavity (most frequently the lowest order mode). These include geometrical methods (via lenses, spherical minors, apertures, etc.), methods based on index guiding (waveguide and fiber lasers), gain guiding, Fourier transform methods, the use of optical nonlinear elements, and others known in the art.

VBGs recorded in photo-thermo-refractive (PTR) glass have enabled extremely narrow-band spectral and angular filters. These filters have successfully been used for longitudinal (spectral) and transverse (spatial) mode selection in laser resonators where the main emphasis was on spectral narrowing, stabilization, and mode locking of different types of lasers. One-dimensional transverse mode selection has been successfully demonstrated by means of transmitting VBGs, which are characterized by a narrow plane angle of acceptance. The use of one dimensional transverse mode selection has enabled a dramatic increase in brightness of high power semiconductor lasers that typically produce single transverse mode emission along a fast axis and multimode emission along the slow axis of such devices. The use of a single transmitting VBG with a narrow plane acceptance angle that selected a single transverse mode along the slow axis provided conversion of a multimode diode laser to a single mode emitter. As disclosed in U.S. Pat. No. 7,394,842, the subject matter of which is incorporated herein by reference in its entirety, a reflecting VBG was used in an external resonator of a semiconductor laser for 1-D transverse mode selection along the slow axis. A cylindrical focusing lens was used to adjust a plane angle of convergence of a laser beam in the plane of a diode waveguide (slow axis) with the plane angle of acceptance of an R-VBG. However, no opportunity for the use of such elements for two-dimensional (2-D) transverse mode selection was disclosed nor enabled.

Great progress in producing fiber lasers having increased power has attracted strong attention to increasing the brightness of such lasers systems. Multimode fibers with large optical mode fields are frequently used in fiber lasers to provide increased output power and/or pulse energy. The most common technique to ensure single transverse mode operation of such a fiber laser is to provide selective loss to higher-order transverse modes by fiber bending or fiber cladding design. These approaches are not ideal and typically lead to lower output power and a slightly bean-shaped fiber mode profile. However coiling multimode fiber is customarily used and even recommended by fiber manufacturers today. The coiling radius has to be small enough to introduce sufficient loss to higher-order modes, but large enough to not detrimentally affect the lowest-order transverse mode. Coiling high power laser fiber to small radii results in power loss, fatigue, and a decreased reliability, and is not always practical, especially in single frequency applications where lasing and amplifying fibers have to be kept short; the coiling loss at radii of a few centimeters that still allows for reasonable total power loss is not always enough to provide sufficient higher-order transverse mode suppression to establish single mode operation.

Transverse mode selection in free-space lasers (solid state, liquid, and gas) is still produced by a proper choice of the ratio between aperture size and resonator length. Moreover, the classical basic design principle for a single-transverse-mode resonator is to provide a single Fresnel zone at an output coupler, which puts strong restrictions on apertures and lengths of single-transverse-mode resonator lasers.

In view of the challenges and known shortcomings, and the resulting problems involved in laser design appreciated by those skilled in the art, the inventors have recognized the advantages and benefits of a practical and robust solution directed especially, but not limited to, two-dimensional spatial mode selection, improving spatial beam quality, simultaneous spatial and spectral mode selection, increased brightness, eliminating aperture confinement, reducing power loss, reducing system size and weight, improving reliability, and others. Solutions to these issues, especially as applicable to free-space (rods, discs, slabs, etc) and multimode waveguide (fiber or planar devices) lasers with solid, liquid, or gas gain media as provided by the embodied invention, will be particularly advantageous.

### SUMMARY

Embodiments of the invention are directed to laser systems with free-space optical resonators that incorporate a reflection-volume Bragg grating (R-VBG) as a resonant reflector and a means for creating a solid convergence angle (cone) of the optical beam propagating to the R-VBG in the resonator. The associated method embodiments involve adjusting a solid convergence angle of a propagating optical beam in the resonator to at least partially fall within a known solid acceptance angle of an R-VBG resonator reflector. These apparatus and method embodiments enable, among other results, the two-dimensional selection of a specific transverse mode or a combination of transverse modes output from the optical resonator by adjusting the degree to which the convergence cone of the propagating optical beam falls within the solid acceptance angle of the R-VBG reflector. The embodied invention further enables free-space resonator-based lasers such as, but not limited to, large mode or multimode fiber, rod-type, solid state, and gas gain-media lasers to exhibit improved spatial beam quality, provide simultaneous spatial and spectral mode selection, exhibit increased brightness, eliminate or significantly reduce resonator aperture confinement, eliminate or significantly reduce power loss, have reduced size and weight, and higher reliability, and other attributes over like laser systems employing conventional approaches to transverse mode selection and operative parameter improvement.

An embodiment of the invention is directed to a laser system. An embodied laser system includes a free-space, multi-mode optical resonator having an aperture from which an optical beam characterized by an average beam divergence will exit, and an R-VBG resonator reflector having a known solid acceptance angle; an optical gain component coupled with the optical resonator; and a suitable optical focusing component disposed in-between the aperture and the R-VBG to effect a solid convergence angle of the optical beam within the solid acceptance angle of the R-VBG. In various, exemplary, non-limiting aspects of the embodied laser system:

the R-VBG is disposed in a focal plane of the focusing component;

the R-VBG is disposed in a non-focal plane, converging, or diverging region of the focusing component in such a manner so as to return at least a portion of the reflected radiation to the optical gain component;
the R-VBG is disposed immediately adjacent the focusing component;
the laser system further includes one or more optical components having the capability to reimage the light reflected from the R-VBG at the aperture of the resonator

the R-VBG is integrally recorded in the focusing component;

the focusing component is a lens;

the focusing component is a minor;

the optical gain component is one of a fiber, a solid state, a liquid, and a gas gain-medium;

the focusing component is movable so as to have the capability to change the convergence angle of the optical beam;

the laser system has only a single transverse mode output;

the R-VBG is disposed at normal incidence to the optical beam.

An embodiment of the invention is directed to a method for two-dimensional transverse mode selection in an optical resonator. An embodied method includes the steps of providing an optical resonator having a feedback element at an end of the optical resonator, and an optical gain component coupled with the optical resonator; providing a reflecting volume Bragg grating (R-VBG) along an optical axis of the optical resonator, characterized by a reflection spectrum that falls within an amplification spectrum of the optical gain component, and a solid acceptance angle, wherein the R-VBG forms another end of the optical resonator; propagating a beam in the optical resonator along the optical axis to the R-VBG, wherein the propagating beam is characterized by a spectrum and a divergence angle; effecting a solid convergence angle of the propagating beam as it propagates to the R-VBG; and, adjusting the solid convergence angle of the propagating beam to at least partially fall within the solid acceptance angle of the R-VBG for the two-dimensional angular selection of at least one transverse mode. In various, exemplary, non-limiting aspects of the embodied method, the steps include:

providing an optical focusing component to effect the solid convergence angle of the propagating beam;
adjusting a position of at least one of the focusing component and the R-VBG to return at least a portion the reflected beam to the gain component;

propagating a cylindrically- or near cylindrically-symmetrical beam;

providing only a single R-VBG for the two-dimensional selection of the at least one selected transverse mode;

providing at least one of a fiber, a solid state, a liquid, and a gas gain-medium;

adjusting the solid convergence angle of the selected mode of the propagating beam to completely fall within the solid acceptance angle of the R-VBG;

reflecting at least one selected transverse mode from the propagating beam from the R-VBG;
adjusting the divergence of the propagating beam such that only the lowest-order transverse mode of the propagating beam completely overlaps with the solid acceptance angle of the R-VBG, thereby reflecting only the lowest-order transverse mode from the R-VBG;

focusing the propagating beam onto the R-VBG;
selecting at least one different transverse mode from the propagating beam for reflection from the R-VBG by changing the convergence of the focused propagating beam;

disposing the R-VBG at an angle to the propagating beam such that the propagating beam strikes the R-VBG at normal incidence;

providing a retro-reflector and disposing the R-VBG at an angle to the incident propagating beam such that there is an arbitrary angle between the wave vector of the propagating beam and the grating vector of the R-VBG;

disposing the R-VBG in a converging or a diverging non-focal region of the propagating beam, and reimaging the light reflected from the R-VBG at the output of the optical resonator;
providing a lens having the R-VBG recorded therein;

performing any step consists of not confining an output aperture dimension of the resonator.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention and together with the description serve to explain the principles and operation of the invention

### BRIEF DESCRIPTION OF THE DRAWINGS

The present invention will be more fully understood and appreciated by reading the following Detailed Description in conjunction with the accompanying drawings, in which:

FIG. 1 schematically illustrates the divergence of a focused beam optimized such that: (a) the lowest order mode completely overlaps with the grating acceptance angle (cone); and (b) a higher order mode has partial overlap, according to an exemplary embodiment of the invention;

FIG. 2 schematically illustrates a 3D (solid state, liquid, or gas) laser resonator and transverse mode selection in the resonator by focusing a beam with a lens L1 and reflecting the beam with a reflecting-VBG (R-VBG), according to an exemplary embodiment of the invention;

FIG. 3 schematically illustrates: A) a gain element with narrow luminescence spectra; B) a gain element with a broad luminescence spectra: C) a gain element with broad luminescence spectra with a diaphragm; and, D) a gain element with broad luminescence spectra with a screen, according to illustrative embodiments of the invention;

FIG. 4 schematically illustrates a multimode fiber laser and transverse mode selection by an R-VBG, according to illustrative embodiments of the invention;

FIG. 5 shows near-field profiles of a beam from the fiber laser of FIG. 4 when the R-VBG is placed in a parallel beam, according to an illustrative aspect of the invention;

FIG. 6 shows beam profiles in the far-field of the fiber laser of FIG. 4 when the R-VBG is placed in a convergent beam near the focal plane, according to an exemplary aspect of the invention;

FIG. 7 schematically illustrates a multimode fiber laser and simultaneous longitudinal and transverse mode selection by an R-VBG: a) where the R-VBG is disposed immediately adjacent the focusing lens; and, b) where the R-VBG is recorded in the focusing lens, according to illustrative aspects of the invention; and

FIG. 8 schematically illustrates transverse mode selection in a broad area laser using an R-VBG, according to an exemplary aspect of the invention.

### DETAILED DESCRIPTION OF NON-LIMITING, EXEMPLARY EMBODIMENTS OF THE INVENTION

The embodied invention provides an apparatus and method for, among other things, two-dimensional angular selection in a free-space optical resonator by a reflecting-VBG (R-VBG). The angular selectivity of an R-VBG with a grating vector parallel to the wave vector of an incident beam has a cylindrical symmetry with respect to the grating vector. The acceptance angle of any VBG is directly related to the Bragg condition and, for an R-VBG, it manifests itself as an acceptance cone (solid angle) that is ideally suited to match the cylindrical geometry of transverse modes in free-space resonators based on multimode optical fibers, solid state rods, and gas cells. The angular selectivity can be designed to be anywhere from a few tenths of milliradians (mrad) to tens of mrad.

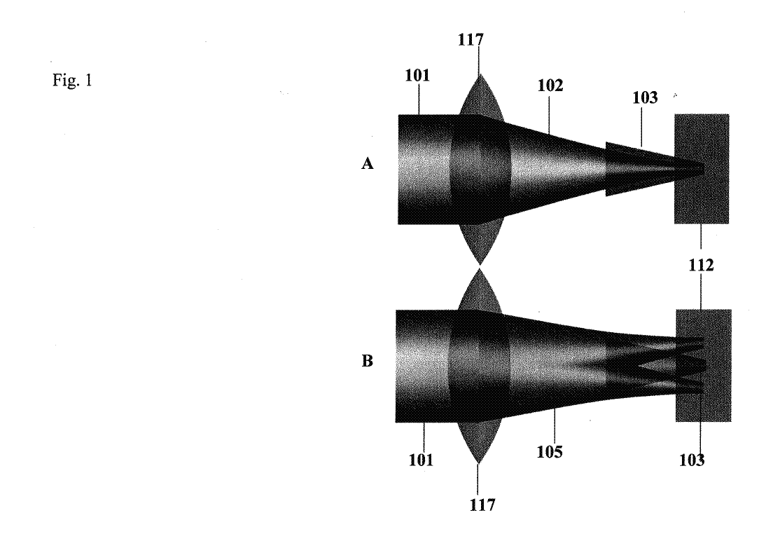

Contrary to the functioning of a transmitting VBG that has a plane angle of acceptance, an R-VBG has a solid angle of acceptance (angular cone). Thus, such an element can enable 2-D spatial selection of optical beams. However, the solid angle of acceptance of available R-VBGs is considerably wide compared to the beam divergence in a free-space laser resonator. As illustrated in FIG. 1, the average beam divergence 101 from the resonator output can be adjusted to at least partially or, more advantageously, completely fall within the solid angle of acceptance 103 of the R-VBG 112 (FIG. 1A) simply by focusing the diverging beam to have an appropriate numerical aperture (NA) with an optical focusing element such as, but not limited to, a lens 117 or a mirror (not shown). In this focused beam, spatial (transverse) modes 102 and (higher order mode) 105 (FIG. 1B) with different radial and angular mode numbers have slightly different divergences within the solid light cone produced by the focusing component. Therefore, for a known solid angle of acceptance 103 of the R-VBG and a properly adjusted solid convergence angle of a laser beam having cylindrical symmetry and propagating in free space, the reflection coefficient for different modes 102 and 105 will be different, resulting in different losses for different transverse modes. As illustrated, lowest order mode 102 will be reflected by the R-VBG, while a higher-order mode 105 is transmitted by the R-VBG because it falls outside of the acceptance cone of the R-VBG. This mode selection is produced within a solid angle and can be used for various cylindrical-type optical resonators operating in free space.

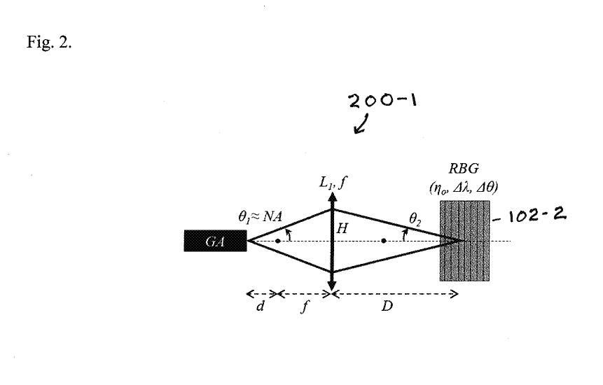

In a more particular illustrative aspect, divergence matching of the lowest order or any selected transverse mode to the solid acceptance angle of the R-VBG can be accomplished by focusing the propagating resonator beam onto the grating. When the focused beam is incident on the grating, only the radiation within the solid acceptance angle of the grating will be reflected, whereas the rest will be transmitted. As shown in FIG. 2, the divergence θ₂ of the focused propagating beam can be controlled by a focusing element such as a lens, L1, by changing the distance between the front facet of the gain element and the lens by an amount d so that only the lowest order transverse mode completely overlaps with the solid acceptance angle of the R-VBG and is reflected (see FIG. 1A), while all other higher-order transverse modes have minimal overlap and are transmitted (see FIG. 1B).

Parameters for optimal adjustment between divergence of a beam emitted by a gain element and the solid acceptance angle of a VBG can be modeled with the use of coupled wave theory (see H. Kogelnik, Coupled wave theory for thick hologram gratings, The Bell System Technical Journal, 48 (1969), 2909-2946), which allows modeling of transmitting (Igor V. Ciapurin, Leonid B. Glebov, Vadim I. Smirnov, Modeling of phase volume diffractive gratings, part 1: transmitting sinusoidal uniform gratings, Optical Engineering, 45 (2006), 1-9) and reflecting (I. Ciapurin, D. Drachenberg, V. Smirnov, G. Venus, L. Glebov, Modeling of phase volume diffractive gratings, part 2: reflecting sinusoidal uniform gratings (Bragg mirrors), Optical Engineering, to be published) VBGs (T-VBGs), the subject matter of all of which is hereby incorporated by reference in its entirety. The imaging system for matching the divergence of the incident propagating beam and the solid acceptance angle of the R-VBG can be designed for any given R-VBG.

### Theory

The peak diffraction efficiency (η₀), spectral selectivity (Δλ^{HWFZ}), and angular selectivity (Δθ^{HWFZ}) of a reflecting VBG depends on its thickness (t), refractive index modulation (δn), and the angle of incidence in the medium (θₘ*). The peak diffraction efficiency is given by

$${η}_{0} = {tanh}^{2} \frac{π ( t \cdot δ n )}{{λ}_{0} \vert cos {θ}_{m}^{*} \vert} \qquad ( 1 )$$

The half-width first-zero spectral width can be calculated as

$${Δλ}^{HWFZ} = \frac{{{λ}_{0}^{2} ( {( atanh \sqrt{{η}_{0}} )}^{2} + {π}^{2} )}^{1 / 2}}{2 π \cdot {n}_{av} \cdot t \vert cos {θ}_{m}^{*} \vert} \qquad ( 2 )$$

A relationship between the angular and spectral selectivity can be derived from the Bragg condition expressed in differential form:

$${Δθ}^{HWFZ} = {( {tan}^{2} {θ}_{m}^{*} + \frac{2 \cdot Δ {λ}^{HWFZ}}{{λ}_{0}} )}^{1 / 2} + tan {θ}_{m}^{*} \qquad ( 3 )$$

For normal incidence (θₘ*=0) these equations may be simplified as:

$$\begin{matrix}{η}_{0} = {tanh}^{2} \frac{π ( t \cdot δ n )}{{λ}_{0}} & ( 4 ) \\ Δ {λ}^{HWFZ} = \frac{{{λ}_{0} [ {( t \cdot δ n )}^{2} + {λ}_{0}^{2} ]}^{1 / 2}}{2 \cdot {n}_{av} \cdot t} & ( 5 ) \\ {Δθ}^{HWFZ} = {( \frac{{[ {( t \cdot δ n )}^{2} + {λ}_{0}^{2} ]}^{1 / 2}}{{n}_{av} \cdot t} )}^{1 / 2} & ( 6 )\end{matrix}$$

Using equations (4)-(6), a reflecting VBG can be designed for the desired diffraction efficiency and angular selectivity.

An example of such modeling is illustrated as follows. Starting with the following parameters of a desired R-VBG output coupler: λ₀=1 μm, η₀=30%, Δλ^{HWFZ}=50 pm, the model provides a required thickness, refractive index modulation, and angular selectivity, respectively, as: t=6.79 mm, δn=28.8 ppm, Δθ^{HWFZ}=10 mrad.

The divergence of the incident beam can now be matched to the angular selectivity of the R-VBG by using, e.g., a focusing lens L₁, as shown in FIG. 2. For small angles and finite distances, the following can be derived:

### Divergence at V-RBG,

$${θ}_{2} = {θ}_{1} \cdot \frac{d}{f} ;$$

Minimum lens half-aperture, H=(d+f) tan θ₁.
Distance from lens to new waist,

$$D = f \cdot ( 1 + \frac{f}{d} ) ;$$

New waist,

$${w}_{2} = \frac{{w}_{1} \cdot D}{d + f} .$$

This simple modeling for monochromatic radiation enables designing resonators with matched beam divergence and solid acceptance angle of an R-VBG for different gain media such as fibers, solid state elements, or cells filled with liquids or gases.

An example of this modeling was done for a multimode fiber laser that includes a fiber having a 20 μm core diameter and 0.07 NA, and the V-RBG described above (θ₂Δθ^{HWFZ}). For a lens of ½″ diameter (70% clear aperture gives H≈4.5 mm), the required focal length is f=56 mm; lens displacement from the focal plane in FIG. 2, d=8 mm. The waist diameter is 140 μm at ˜450 mm from the lens.

Reflecting VBGs can be used not only for normal incidence beams but at arbitrary angles between a grating vector and a wave vector of an incident beam. In such a scenario, however, the angular selectivity of an R-VBG will be different for orthogonal directions that correspond to the plane of incidence and perpendicular thereto. This feature brings additional opportunities for selection of transverse modes that do not have cylindrical symmetry.

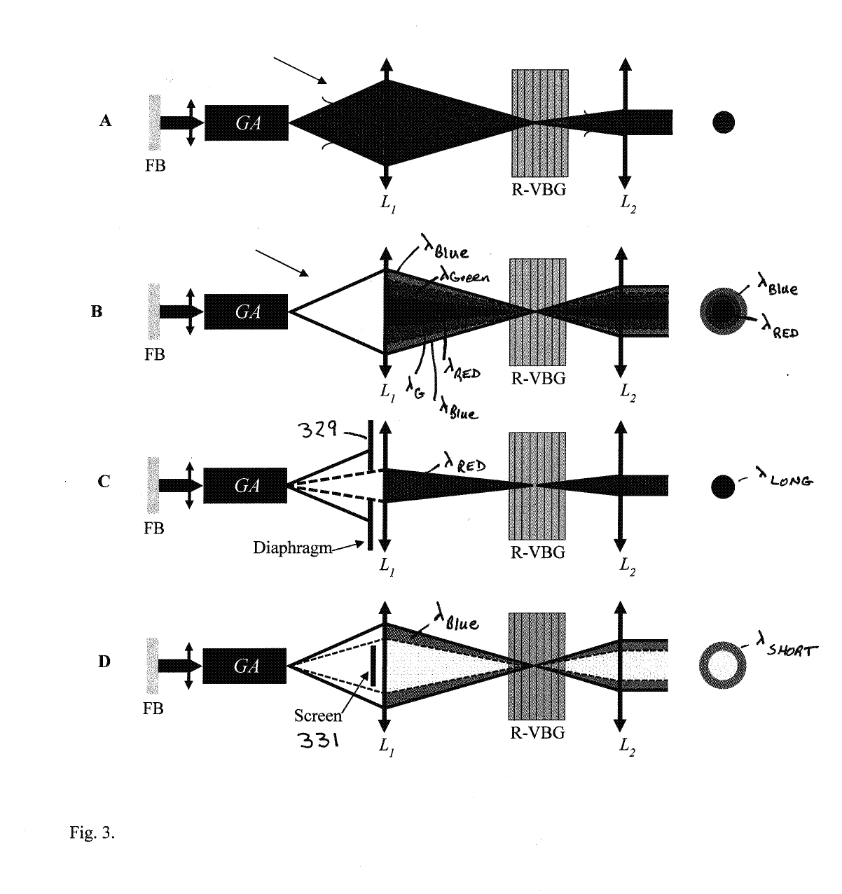

It is known that the Bragg (resonant) wavelength of a VBG is shorter for larger incidence angles. This feature, in combination with the embodied design geometry, provides for simultaneous selection of both lowest-order transverse modes that propagate within the solid acceptance angle (angular selection) and longitudinal modes that satisfy the Bragg condition within the solid acceptance angle of the R-VBG (spectral selection). For gain media (GA) with narrow luminescence spectra (e.g., gas and rare earth doped solid state lasers), the fundamental transverse modes with wavelengths matching the Bragg condition of the R-VBG will be selected (FIG. 3A). For gain media with wide luminescence spectra (e.g., semiconductors or transition ion-doped solid state lasers), a wider bandwidth of longitudinal modes (wavelengths) will satisfy the Bragg condition for the transverse modes propagating within the solid acceptance angle of the R-VBG (FIG. 3B). Diffraction from the R-VBG will produce a radial distribution with lower order transverse modes and longer wavelengths (λ_{RED}) towards the center and higher order transverse modes and shorter wavelengths (λ_{BLUE}) towards the perimeter. In the latter case, placing a diaphragm 329 (having a central clear aperture; FIG. 3C) in the plane of the lens L₁ will provide feedback for longitudinal modes with the longer wavelengths (satisfying the R-VBG Bragg condition at near normal incidence). On the other hand, placing a screen 331 at the optical axis (FIG. 3D) will provide feedback for longitudinal modes with the shorter wavelengths (satisfying the R-VBG Bragg condition at larger incidence angle). FIG. 3 illustrates this feature for: A) a gain element with narrow luminescence spectra; B) a gain element with broad luminescence spectra; C) a gain element with broad luminescence spectra with a diaphragm; and, D) a gain element with broad luminescence spectra with a screen. The sizes of the screen and diaphragm can be adjusted to provide feedback for desired spectral components.

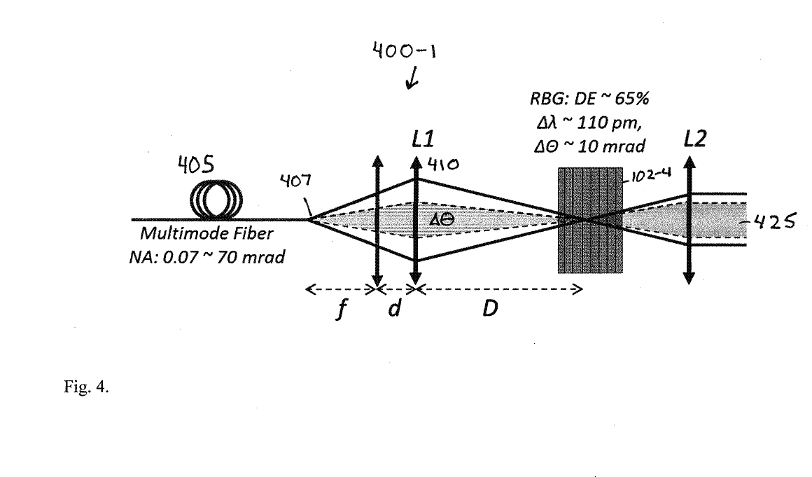

FIG. 4 shows an example of a multimode fiber laser resonator 400-1 according to the embodied invention. The resonator includes an active, multi-mode optical fiber 405 with a divergent output beam, a movable focusing lens L1 410, an R-VBG 102-4, and re-collimating lens L2 420. The active fiber 405 (nLight/Liekki) had a 20 μm core diameter and a length between 0.7 to 1 m. The fiber core was highly doped with Yb and the small, 125 μm cladding diameter provided high pump absorption over the short length. The fiber was loose, not coiled, nor fastened to a heat sink. The fiber core had a N.A. equal to 0.07, corresponding to a beam divergence at its output of approximately 70 mrad. The fiber supports about 10 different transverse modes. Lens L1 had a focal length f=8 mm and N.A.=0.5. The R-VBG had a spectral bandwidth Δλ≈100 μm (FWHM) and an acceptance cone Δθ≈10 mrad (FWHM). The grating reflection coefficient for a plane wave at normal incidence at 1064 nm was about 60%.

For comparison, a conventional linear laser cavity was established between a highly reflecting dielectric minor (not shown) and an R-VBG placed in a collimated beam in free space. Pump light at 976 nm was coupled into the fiber cladding. At 10 W of launched pump power the laser emitted about 5 W of output power centered at 1064 nm with a spectral bandwidth of less than 10 pm. It was found that coiling the short fiber even to a very tight radius did not provide single transverse mode operation for the disclosed laser geometry.

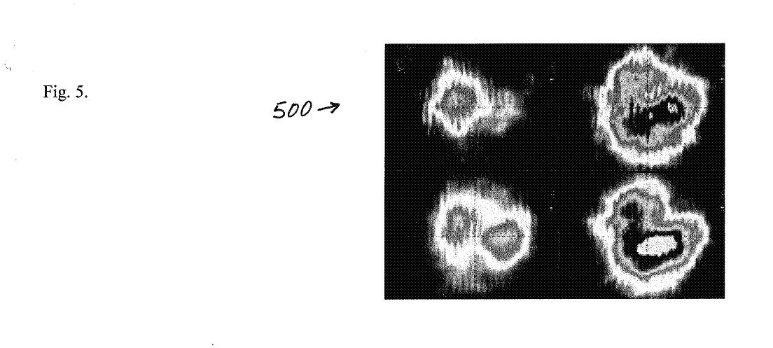

When the R-VBG was placed and aligned in the collimated (parallel) beam, the output beam profile was unstable and showed several transverse modes as well as transitions between them with time and with any external stimulation such as mechanical vibrations, temperature change, and varying pump power. FIG. 5 shows typical mode patterns 500 taken at different points in time.

According to the embodied invention, when the R-VBG was placed in a focused beam via lens L1 (FIG. 4), the mode pattern became very stable. When the focused beam was incident on the R-VBG, only a cone Δθ of ˜10 mrad was reflected, whereas the remaining part of the beam 425 was simply transmitted. Different transverse modes and their combinations can be selected by changing the convergence of the focused beam, which is achieved by simply translating the lens L1 by the distance d as illustrated in FIG. 4. As a result, the convergence of the beam focused by the lens L1 can be optimized so that only the lowest order mode receives feedback to establish lasing, while all other higher-order modes incur higher losses and remain below threshold.

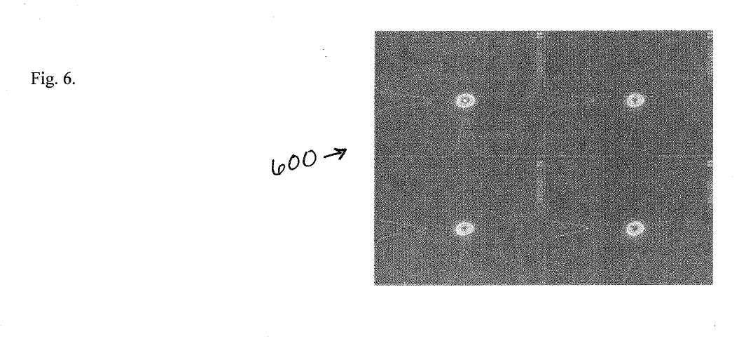

FIG. 6 shows the beam profiles 600 in the far zone of the laser when the R-VBG was placed in the focused beam. From threshold all the way up to 5 W of output power, the fiber laser maintained the single transverse mode, which was also stable against vibration and intentional misalignments in the setup. No decrease in total output power and slope efficiency was observed compared to the alignment of the R-VBG in the collimated beam as discussed above. The R-VBG in this case works as an output coupler that provides feedback for only the single transverse mode and the total energy stored in the gain medium is emitted in this mode.

For a properly selected lens and the R-VBG, matching of beam divergence and the grating angular acceptance cone was achieved in a 4f re-imaging configuration, such that d=f and D=2f in the system of FIG. 4. For different R-VBGs having different angular selectivity and different fibers having different spectra of transverse modes, it is thus possible to design an imaging optical system that provides desirable difference in losses (reflection coefficients) between these modes.

The results illustrated in FIG. 6 were achieved with the fiber laser 400-1 depicted in FIG. 4. The small output aperture of the optical fiber leads to high divergence of the exiting beam. To provide proper feedback, the image of the end of the fiber was projected to the R-VBG by lens L1. For different multimode laser resonators with larger apertures and lower divergence, which operate in free-space but not in a waveguide, a similar imaging system can be designed to provide significant difference of losses for different transverse modes reflected by an R-VBG.

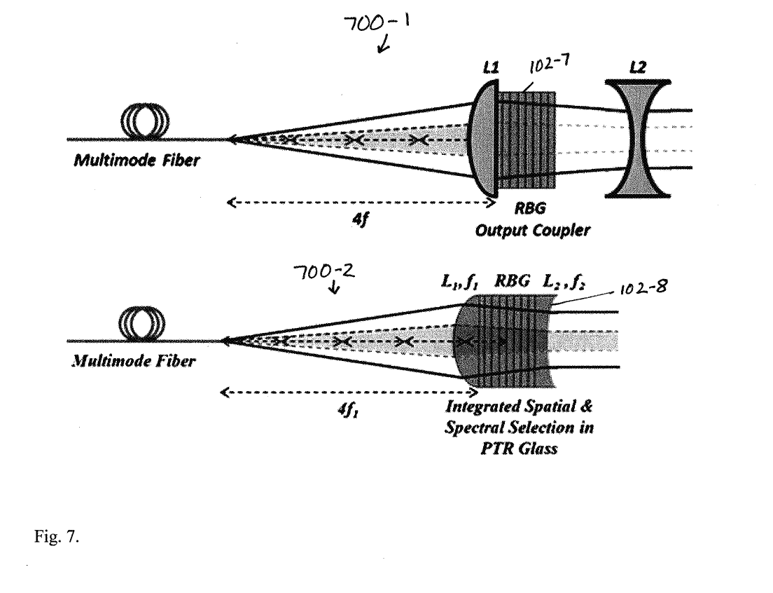

According to a related but different aspect as illustrated in FIG. 7a, the solid cone of light 733 effected by the focusing lens L1 is not focused into the R-VBG 102-7; rather, since the divergence of a focused beam is constant at any point in space, the R-VBG can be placed at any position of the convergent (or divergent) beam if an imaging system returns the radiation to the resonator. FIG. 7a illustrates a setup for simultaneous longitudinal and transverse mode selection in a multimode fiber laser 700-1 in an exemplary 4f configuration, where L1 is a plano-convex lens with focal length f and L2 is a re-collimating lens. Here, the R-VBG 102-7 is disposed adjacent the plano surface of lens L1. A major benefit of this modified configuration for high power laser systems is that the R-VBG is not placed in the focal plane of the lens, so the risk of laser induced damage is avoided.

A further modification of this approach is to record the R-VBG 102-8 in the lens L1 itself, as illustrated in FIG. 7b. This modification would enable the monolithic design of an output coupler and increase the tolerance of such a resonator to shock and vibration.

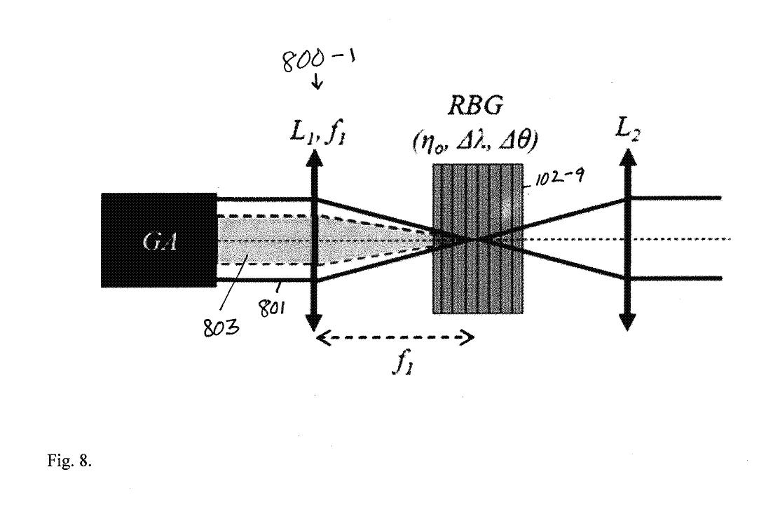

FIG. 8 illustrates an advantageous aspect of the invention, where a lens L₁ is used in a three-dimensional resonator 800-1 having relatively low diffraction limited divergence 801 to produce additional focusing of the beam for adjustment of its convergence with a solid acceptance angle 803 of the R-VBG 102-9.

We have demonstrated that a combination of beam divergence/convergence and a solid angle of acceptance of a reflecting-VBG can be found that provides selection of transverse modes for free-space optical resonators with a very wide range of parameters. The classical basic design principle for a single-transverse-mode resonator is to provide a single Fresnel zone at an output coupler. This principle puts strong restrictions on apertures and lengths of single transverse mode laser resonators. The embodied approaches require a single Fresnel zone within the solid angle of acceptance of an R-VBG. This requirement can be satisfied for a very wide range of resonator parameters by matching of the convergence angle of the focused beam and the solid angle of acceptance of the R-VBG. This approach can be used for various free-space resonators for fiber, solid state, liquid, or gas lasers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any non-claimed element as essential to the practice of the invention.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

We claim:

1. A method for two-dimensional transverse mode selection in an optical resonator, comprising:
providing an optical resonator having a feedback element at an end of the optical resonator, and an optical gain component coupled with the optical resonator;
providing a reflecting volume Bragg grating (R-VBG) along an optical axis of the optical resonator, characterized by a reflection spectrum that falls within an amplification spectrum of the optical gain component, and a solid acceptance angle, wherein the R-VBG forms another end of the optical resonator;
propagating a beam in the optical resonator along the optical axis to the R-VBG, wherein the propagating beam is characterized by a spectrum and a divergence angle;
effecting a solid convergence angle of the propagating beam as it propagates to the R-VBG;
adjusting the solid convergence angle of the propagating beam to at least partially fall within the solid acceptance angle of the R-VBG for the two-dimensional angular selection of at least one selected transverse mode.

2. The method of claim 1, further comprising providing an optical focusing component to effect the solid convergence angle of the propagating beam.

3. The method of claim 2, wherein adjusting the solid convergence angle of the propagating beam further comprises adjusting a position of at least one of the focusing component and the R-VBG to return the reflected beam to the gain component.

4. The method of claim 1, wherein propagating a beam in the optical resonator further comprises propagating a cylindrically- or near cylindrically-symmetrical beam.

5. (canceled)

6. The method of claim 1, wherein the gain component comprises at least one of a fiber, a solid state, a liquid, and a gas gain medium.

7. The method of claim 1, wherein the step of adjusting the solid convergence angle of the propagating beam further comprises adjusting the solid convergence angle of the propagating beam to completely fall within the solid acceptance angle of the R-VBG.

8. (canceled)

9. (canceled)

10. (canceled)

11. (canceled)

12. The method of claim 1, further comprising disposing the R-VBG at an angle to the propagating beam such that the propagating beam strikes the R-VBG at normal incidence.

13. (canceled)

14. (canceled)

15. (canceled)

16. The method of claim 1, wherein performing any step consists of not confining an output aperture dimension of the resonator.

17. (canceled)

18. A laser system, comprising;
a free-space, multi-mode, cylindrical- or near-cylindrical-optical resonator having an aperture from which an optical beam characterized by an average beam divergence will exit, and an R-VBG resonator reflector having a known solid acceptance angle;
an optical gain component coupled with the optical resonator; and
an optical focusing component disposed in-between the aperture and the R-VBG suitable to effect a solid convergence angle of the optical beam within the solid acceptance angle of the R-VBG.

19. (canceled)

20. (canceled)

21. The laser system of claim 18, further wherein the R-VBG is disposed in a non-focal plane, converging, or diverging region of the focusing component in a manner to return the reflected radiation to the optical gain component.

22. (canceled)

23. (canceled)

24. (canceled)

25. The laser system of claim 18, wherein the focusing component is a lens.

26. (canceled)

27. The laser system of claim 18, wherein the optical gain component is one of a fiber, a solid state, a liquid, and a gas gain-medium.

28. The laser system of claim 18, wherein the focusing component is movable so as to have the capability to change the convergence angle of the optical beam.

29. (canceled)

30. (canceled)
